(19) United States
(12) Patent Application Publication
(10) Pub. No.: US 2012/0107620 A1
(43) Pub. Date: May 3, 2012

(54) N-HALAMINE BASED BIOCIDAL COATINGS COMPOSED OF ELECTROSTATICALLY SELF-ASSEMBLED LAYERS

(75) Inventor: Steven N. Kaganove, Midland, MI (US)

(73) Assignee: Michigan Molecular Institute, Midland, MI (US)

(21) Appl. No.: 12/946,357

(22) Filed: Nov. 15, 2010

Related U.S. Application Data
(60) Provisional application No. 61/281,498, filed on Nov. 18, 2009.

(51) Int. Cl. B32B 27/08; B05D 5/00; B05D 1/18; B05D 1/28; B05D 3/10; B05D 1/02

(52) U.S. Cl. 428/424.2; 428/515; 428/476.3; 427/340; 427/140

(57) ABSTRACT

The present invention provides a composition comprising an antimicrobial bilayer coating on a substrate which coating comprises:
(1) a polyionic material, in alternating layers, where one layer is a cationic polymer containing —NHR₁ or —C(O)NHR₂ groups, where R₁ and R₂ are independently hydrogen, straight- or branch-chain C₁-C₁₀ alkyl, phenyl, benzyl, or C₆-C₁₄ aryl; and another layer is an anionic polymer containing —COOH or —COOR groups, where R is straight- or branch-chain C₁-C₁₀ alkyl, phenyl, benzyl, or C₆-C₁₄ aryl; and
(2) At least two full bilayers are coated on the substrate; and
(3) the layers are crosslinked through amide, imide, urea, or carbamate bonds; and
(4) at least 1% of the amine or amide N—H groups in the coating are converted to N—X, where X is Cl or Br.

The bilayers, where an anionic outermost layer is present, is preferred.

These coating compositions, applied to a substrate, are then crosslinked and finally treated with aqueous hypochlorite when N—X is N—Cl.

The substrate that is coated can be sterilized prior to applying the coating composition, but it is not required to do so. These coatings are useful for military and hospital equipment and environments, especially against spores.

### CROSS-REFERENCE TO RELATED APPLICATION

This application claims priority from U.S. Provisional Application 61/281,498, filed Nov. 18, 2009.

### FEDERALLY SPONSORED RESEARCH STATEMENT

This invention was made with Government support under Award No. IIP-0810595 entitled “Nanostructured Biocidal Coatings Targeting Spore-Forming Bacteria”, and Award No. IIP-0945303 entitled “Disinfection of Spore-Forming Bacteria with Advanced Functional Surface Coatings”, both from the National Science Foundation (NSF) to Dendritech, Inc. The Government has certain rights in this invention.

### BACKGROUND OF THE INVENTION

1. Field of the Invention

Coatings that convey inherent antimicrobial properties to solid and porous surfaces or fabrics are needed for a variety of civilian and military applications. For the latter, decontamination of vehicles, equipment, shelters and uniforms are needed if an attack from biological weapons is known or suspected. Protection of the air intake systems of buildings is also needed, because these could be vulnerable to the malicious delivery of pathogenic microorganisms. Protecting the safety of water supplies is also a priority. For civilian applications, there is a need for disinfection of medical devices and surfaces in healthcare facilities to counteract the spread of nosocomial infections. All these products are also used for elimination of odors or disease-causing organisms.

2. General Discussion

In an era of continually increasing health care needs and costs coupled with an aging population in the United States, hospital-acquired, or nosocomial infections, are a persistent problem. Nosocomial infections are acquired during treatment in a hospital or hospital-like setting, but are secondary to the patient's original condition. Nosocomial infections are also an increasing problem for U.S. military personnel treated at forward deployed medical facilities.

Some of the pathogens responsible for nosocomial infections have become more virulent over time. Although methicillin-resistant Staphylococcus aureus (MRSA) continues to be the most prevalent and most well-known of these; recently Clostridium. difficile has become more widespread and virulent. C. difficile is a spore-forming, gram-positive anaerobic bacillus that produces exotoxins, causes gastrointestinal infections in humans, and is shed in feces. Infection severity can range from asymptomatic colonization to severe disease, including diarrhea, pseudomembranous colitis, toxic megacolon, colonic perforation, and death. Transmission is believed to occur through contact with contaminated surfaces, or the hands of health care personnel. The bacterium can be transmitted in either the active vegetative form, or the metabolically dormant spore form. The latter is often resistant to routine environmental cleaning and disinfection methods typically employed in health care facilities, making transmission more likely.

New disinfection strategies are needed to prevent the spread of pathogens responsible for nosocomial infections, particularly those that are resistant to common antibacterial soaps and cleansers. New disinfection strategies are also needed by the U.S. military because of the persistent threat of the acquisition and use of biological weapons by unfriendly states or terrorist groups. Some potent biological warfare agents include Bacillus anthracis (anthrax) and Yersinia pestis (plague) bacteria, variola virus (smallpox) and flaviviruses (hemorrhagic fevers), and toxins such as botulinum and ricin.

Disinfection strategies that are effective against pathogenic spore-forming bacteria such as B. anthracis and C. difficile are particularly needed because their spores are able to withstand severe environmental stresses, such as heat, drying radiation and many kinds of toxic chemicals, and hence, they are not easy to kill. In both military and health care settings, procedures for the disinfection of surfaces contaminated with B. anthracis and C. difficile spores typically employ treatment with caustic chemicals, such as hypochlorites, peroxides, or aldehydes. These have the potential to damage sensitive furniture or equipment, and they lose effectiveness within hours of application.

3. Description of Related Art

Although there are numerous products and potential products that have been used or described as antimicrobial agents, none describe the present invention.

U.S. Pat. No. 5,126,057 describes small molecule N-halamine structures. There is no teaching of a polymer coating, or layers.

U.S. Pat. No. 6,656,919 describes decontamination of surfaces using a germinating agent and germicide after spores are present.

U.S. Pat. No. 6,812,298 teaches hyperbranched polyureas, polyurethanes, polyamidoamines, polyamides, and polyesters. Their use as a component in a utility of the present invention is not disclosed.

U.S. Pat. No. 7,067,294 relates to immobilized enzymes and polymerizable end-capping agents of very specific types. This is not a layered crosslinked polymer.

Published US 2005/0136522, now U.S. Pat. No. 7,067,294, describes surfaces for protection from toxins, but not biocidal materials or germinants. Published US 2005/0136523, now U.S. Pat. No. 7,270,973, describes surfaces of textiles with a PEM outer layer for protection from bacteria.

Published US 2005/0152955 describes a wound dressing having an antimicrobial coating within the dressing. The layers each can release the antimicrobial material. Here Ag ions are encapsulated in a polyelectrolyte multilayer. This is not a crosslinked polymer.

Published US 2005/0271780 describes the use of a coating for protecting foods. The organic polymer matrix is very broad and does not teach the present polymers.

Published US 2007/0062884 describes the use of N-halamine in 1-10 member rings with N atoms. There is no teaching of crosslinking layers of polymer.

Published US 2007/0065547 describes an encapsulated antimicrobial material with core-shell architecture. These are not the present polymer layers.

Published US 2007/0071713 describes very specific quaternary ammonium functional end-groups, which incorporate heterocyclic ring systems or hydrazine functional groups. The parent patent, U.S. Pat. No. 7,384,626, has a discussion of a layer-by-layer technique but use of base layers of commercial polyelectrolytes is not discussed. No mention of cross-linking or amide groups converted to halogen is present.

Published US 2008/0207774 describes polymeric materials that can be used in combination with a variety of substrates, e.g., personal care products, textiles, metal, cellulosic materials, plastics, and others. This material is 1) a latex polymer comprising a polymerization product of: a) at least ethylenically unsaturated first monomer and b) at least ethylenically unsaturated monomer that is anionic or a precursor to an anion; 2) at least one active component at least partially encapsulated within the latex polymer; and 3) optionally, at least one sterically bulky component incorporated into the latex polymer; wherein the composition provides antimicrobial activity. Such encapsulation implies only physical or steric entrapment of the active.

Published WO 2008/156636 discloses compositions that include dendrimers, hyperbranched polymers, and linear PEI, all with either hydantoin terminal groups or a mixture of hydantoin and quaternary ammonium end-groups. These compositions encapsulate small molecule germinants to aid in their antimicrobial use. It was found that these encapsulated germinants have little or no activity on spores that come into contact with these compositions.

Thus it is clear that better compositions for use as disinfection agents in the health care industry and military uses are needed.

### BRIEF SUMMARY OF THE INVENTION

The present invention provides a composition comprising an antimicrobial bilayer coating on a substrate which coating comprises:
(1) a polyionic material, in alternating layers, where one layer is a cationic polymer containing —NHR₁ or —C(O)NHR₂ groups, where R₁ and R₂ are independently hydrogen, straight- or branch-chain C₁-C₁₀ alkyl, phenyl, benzyl, or C₆-C₁₄ aryl; and another layer is an anionic polymer containing —COOH or COOR groups, where R is straight- or branch-chain C₁-C₁₀ alkyl, phenyl, benzyl, or C₆-C₁₄ aryl; and
(2) at least two full bilayers are coated on the substrate; and
(3) the layers are crosslinked through amide, imide, urea or carbamate bonds; and
(4) at least 1% of the amine or amide N—H groups in the coating are converted to N—X, where X is Cl or Br.

A process for preparing the above composition comprises:
(1) applying to a substrate the polyionic bilayer of claim 1; and
(2) forming amide bonds between the cationic and anionic polymer layers by a chemical dehydrating agent; or
(3) crosslinking the amide bonds in the bilayers by thermal means; and
(4) contacting the coating for about 10 sec to about 2 h with aqueous hypochlorite.

This process to make the coating is further described below and illustrated in FIGS. 1 and 2.

The coating of the present invention where the polymer is in solution may be applied to a surface before it is exposed to spores or bacteria of the types desired to be killed, such as after sterilization, or intended to be killed by use of this coating. The methods for applying the solution are anything that permits the coating to be applied and dried to the substrate, including but not limited to a solution of the polymer in a polar organic solvent or water and then dipping the substrate into the solution one or more times, or spraying the solution onto the substrate, or wiping the solution onto the substrate.

### BRIEF DESCRIPTION OF THE DRAWINGS

FIG. 1 illustrates a cross-sectional view of the substrate and alternating layers of negatively and positively charged polymeric materials that contain amine and carboxylate groups where the functional groups are converted to amide crosslinks by thermal treatment, followed by chlorination with hypochlorite.

FIG. 2 illustrates a [PAA/PAH]₅/PAA/120° C./NaOCl LbL formulation used in Example 5 that provided the highest biocidal activity obtained against B. anthracis spores.

FIG. 3 illustrates the thickness buildup of PAA/PAH multilayer coatings after the deposition of each polyelectrolyte layer on a silicon wafer substrate, as measured by ellipsometry.

FIG. 4 is a bar graph of the results obtained in Example 6.

FIG. 5 is a bar graph of the results obtained in Example 7.

FIG. 6 is a graph of chlorine content of PAA/PAH multilayer coatings on glass slides determined by iodometric titration as a function of the number of polyelectrolyte layers.

### DETAILED DESCRIPTION OF THE INVENTION

### Glossary

The following terms as used in this application are to be defined as stated below and for these terms, the singular includes the plural.
BHI means brain heart infusion broth
Bilayer means a coating structure formed on an article by alternatively applying, in any order, 1 layer of a polyionic material and then 1 layer of a second polyionic material, the two polyionic materials having opposite charges; or the coating formed on a structure by this method; whereby the layers may be intertwined with each other in the bilayer
BSA means bovine serum albumin
CFU means colony-forming units
DCC means 1,3-dicyclohexylcarbodiimide
EDC means 1-ethyl-3-(3-dimethyl-aminopropyl) carbodiimide
h means hour(s)
HBA means hyperbranched polyamides
L means liter(s)
LbL means layer-by-layer that is a process to construct the coatings
min means minutes(s)
mL means milliliter(s)
μL means microliters
nmol means nanomoles
PAA means polyacrylic acid
PAAm means polyacrylamide
PAH means poly(allylamine hydrochloride)
PAMAM dendrimer means poly(amidoamine) dendrimer
PDDA means polydiallyl dimethyl ammonium chloride
PEI means poly(ethyleneimine) in its linear or randomly branched form unless specified as a dendrimer
PEM means polyelectrolyte multilayer(s)
PMA means polymethacrylic acid
Polyionic material means a material having a plurality of charged groups, both polycationic materials and polyanionic materials
PPI means poly(propylenimine) dendrimers
PSS means poly(sodium 4-styrenesulfonate)
sec means second(s)

The present invention provides a series of structurally related, potent antimicrobial coatings that can be applied to a variety of common porous and nonporous surfaces, including metal, glass, plastic, fabrics, and fibers; thereby conveying protection to useful items such as clothing, equipment, and air filtration systems. Particularly of interest are formulations that can be applied to the fibers of typical air filters for the protection of HVAC systems, consequently providing an effective means of making buildings resistant to attack from biological warfare agents, and medical equipment and hospital areas.

It is known that bacterial spores are more difficult to kill than corresponding vegetative cells [e.g., Russell, A. D., Clin. Microbiol. Rev. 3, 99-119 (1990); Rode, L. J. et al., Nature 188, 1132-1134 (1960)], and hence, an antimicrobial coating intended for protection against the most serious biological warfare agents is of little value if it cannot efficiently kill spores. Conversely, a coating that is sufficiently potent to kill bacterial spores would also likely be effective against less hardy microorganisms, such as vegetative bacteria and viruses.

Coatings.

The present invention uses N-halamine functional groups that are part of a crosslinked LbL coating to provide biocidal function. Specifically, the present coating composition comprises an antimicrobial bilayer coating on a substrate which coating comprises:
(1) a polyionic material, in alternating layers, where one layer is a cationic polymer containing —NHR₁ or —C(O)NHR₂ groups, where R₁ and R₂ are independently hydrogen, straight- or branch-chain C₁-C₁₀ alkyl, phenyl, benzyl, or C₆-C₁₄ aryl; and another layer is an anionic polymer containing —COOH or COOR groups, where R is straight- or branch-chain C₁-C₁₀ alkyl, phenyl, benzyl, or C₆-C₁₄ aryl; and
(2) at least two full bilayers are coated on the substrate; and
(3) the layers are crosslinked through amide, imide, urea or carbamate bonds; and
(4) at least 1% of the amine or amide N—H groups in the coating are converted to N—X, where X is Cl or Br.

Generally, an N-halamine is a compound containing one or more nitrogen-halogen covalent bonds that is formed by the chlorination or bromination of imide, amide or amine groups that are present. The polyelectrolyte LbL coating includes one or more layer pairs where the cationic polymer contains amine or amide groups and the anionic polymer contains carboxylate groups. Further, the oppositely charged layers are linked together through amide, urea, or carbamate bonds, and at least 1% of the N—H groups, preferably at least 10%, have been halogenated.

When microbes come into contact with the N—X structures (X is Cl or Br) of N-halamines, a halogen exchange reaction occurs, which kills the microorganisms. Although this process eventually consumes the halogens, the consumed halogens can be fully recharged by another halogen treatment. Such regeneration is done by treating the substrate with bleach by dipping the substrate one or more times into a bleach solution, spraying the bleach solution onto the substrate or wiping the bleach solution onto the substrate. Thus, N-halamines are generally regarded as rechargeable sources of covalently bound halogens.

These present LbL coatings can be constructed from inexpensive commercially available polyelectrolytes, such as polyacrylates and polyamines. These water soluble polymers can be applied to surfaces by applying a solution containing the coating composition in a polar organic solvent or water to a substrate and allowing the mixture to dry forming the coated substrate. Applying the coating composition is done using very simple techniques including but not limited to dipping or immersion of the substrate in a coating bath one or more times, spray coating, spin coating, and even brushing or wiping it on. The durability and solvent resistance of the coatings is enhanced by crosslinking, which also creates amide groups. The amide groups (as well as other N—H functional groups that are present, including amines) are halogenated in situ by treatment with a suitable halogenating agent (such as bleach). The more N—H functional groups that are present per unit area, the more halogen the coating is able to store and release. The concentration of N—H functional groups per unit area increases with increasing thickness. Hence, the biocidal activity of the coatings is directly controlled by the thickness and surface concentration of N—H functional groups. For vegetative E. coli bacteria, thicker coatings result in a faster and more extensive kill. This is illustrated in Table 2 in Example 7, where a five bilayer coating produced a 0.24 log reduction of E. coli bacteria after 20 min of exposure, while a ten bilayer coating produced a 2.9 log reduction after 20 min of exposure. For B. anthracis spores, the highest biocidal activity was obtained with five bilayers, while lower biocidal activity was obtained with greater or fewer bilayers. Under the conditions used, the thickness of five bilayers varied between about 50 to about 80 nm.

Polyionic Materials.

A polycationic material used in the present invention can include any material known to have a plurality of positively charged groups along a polymer chain. For instance, suitable examples of such polycationic materials can include, but are not limited to, poly(allylamine hydrochloride) (PAH), poly(ethyleneimine) (PEI), polydiallyl dimethyl ammonium chloride (PDDA), polyamidoamine dendrimers (PAMAM), poly(propylenimine) dendrimers (PPI), hyperbranched polyamides, polyamidoamines, polyurethanes and polyureas. One preferred polycationic material is poly(allylamine hydrochloride) (PAH). Preferably, the polycationic material has N—H groups that are used for crosslinking to adjacent polyanionic layers, and also for halogenation.

In place of a polycationic material, a polymer that forms hydrogen bonds to the polyanionic material can be used, such as polyacrylamide (PAAm).

A polyanionic material used in the present invention can include any material known to have a plurality of negatively charged groups along a polymer chain. For example, suitable polyanionic materials can include, but are not limited to, polymethacrylic acid (PMA), polyacrylic acid (PAA), poly(4-styrenesulfonic acid) (PSS), a maleic or fumaric acid copolymer, polyamidoamine dendrimers (PAMAM) with carboxylate end-groups, and hyperbranched polyamides, polyamidoamines, polyurethanes and polyureas, each with carboxylate end-groups. One preferred anionic polymer is polyacrylic acid (PAA). Preferably, the polyanionic material has COOH groups that are used for crosslinking to adjacent polycationic layers. Polyacrylic esters can be used as a substitute for polyacids; they adhere to adjacent polyamine layers mainly by hydrogen bond interactions, rather than electrostatic interactions. Similar to polyacrylic acids, however, they will also form amide crosslinks with adjacent polyamines when heated above 100° C. In order to alter various characteristics of the coating, such as thickness, the molecular weight of the polyionic materials can be varied. In particular, as the molecular weight is increased, the coating thickness generally increases. However, if the increase in molecular weight is too substantial, the difficulty in handling may also increase. As such, polyionic materials used in the present invention will typically have a molecular weight Mₙ of about 2,000 to about 500,000. Coating thickness can also be controlled by polymer solution concentration, ionic strength, and solution pH. The latter parameter of solution pH is particularly important in the case of weak polyelectrolyte pairs, such as PAH and PAA, because thickness buildup can be either linear or non-linear depending on the pH of each individual polymer solution of a cationic/anionic pair. This is described by D. Yoo et al. Macromolecules 31, 4309 (1998), and S. S. Shiratori and M. F. Rubner Macromolecules 33, 4213 (2000).

In general, the polyionic solutions mentioned above can be prepared by any method well known in the art for preparing solutions. A general process for preparing the above composition comprises:
(1) applying to a substrate the polyionic bilayer of claim 1; and
(2) forming amide bonds between the cationic and anionic polymer layers by a chemical dehydrating agent; or
(3) crosslinking the amide bonds in the bilayers by thermal means; and
(4) contacting the coating for about 10 sec to about 2 h with aqueous hypochlorite, or other suitable halogenating agent such as aqueous sodium hydroxide (NaOH), followed by liquid bromine (Br₂).

For example, in one embodiment, a polyanionic solution can be prepared by dissolving a suitable amount of the polyanionic material, such as polyacrylic acid having a molecular weight of about 240,000, in water such that a solution having a certain concentration is formed, such as a 0.01 M PAA solution. Once dissolved, the pH of the polyanionic solution can also be adjusted to a desired value by adding a basic or acidic material, such as a suitable amount of 1 N hydrochloric acid (HCl) to adjust the pH to about 3.5.

Polycationic solutions can also be formed in a manner as described above. For example, in one embodiment, poly(allylamine hydrochloride) having a molecular weight of about 50,000 to about 65,000 is dissolved in water to form a 0.01 M PAH solution and the pH is adjusted to about 8.5 by adding a suitable amount of hydrochloric acid and/or sodium hydroxide.

Preparation of the Antimicrobial Coating.

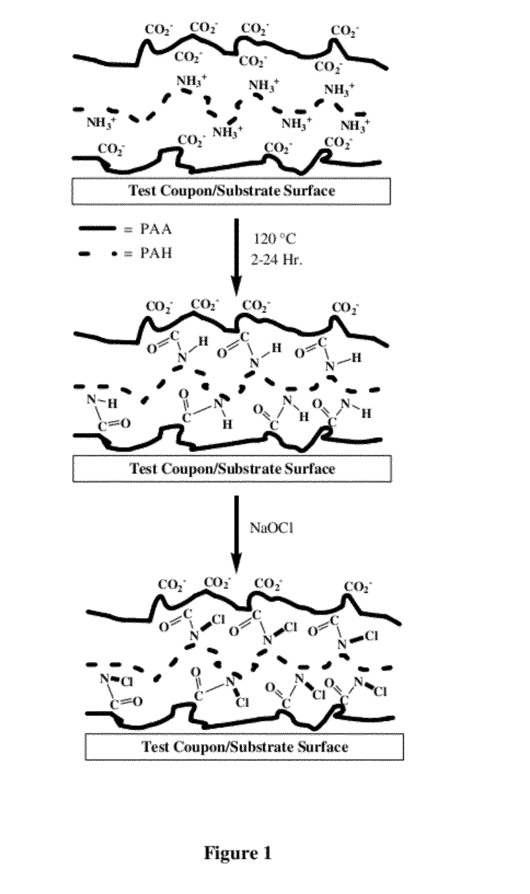

FIG. 1 illustrates the present process to make LbL coatings of this invention.

Application of an LbL coating to a substrate may be accomplished in a number of ways. One coating process embodiment involves solely dip-coating and dip-rinsing steps. Another coating process embodiment involves solely spray-coating and spray-rinsing steps. However, a number of alternatives involve various combinations of spray- and dip-coating and rinsing steps may be designed by a person having ordinary skill in the art.

One dip-coating alternative involves the steps of applying a coating of a first polyionic material to a substrate by immersing in a first solution of a first polyionic material; rinsing by immersing in a rinsing solution; and, optionally, drying the substrate. This procedure can be repeated using a second polyionic material, with the second polyionic material having charges opposite of the charges of the first polyionic material, in order to form a polyionic bilayer. This bilayer formation process may be repeated a plurality of times in order to produce a thicker LbL coating. It has been found in the examples that having the outermost layer an anionic polymer provides the best results against B. anthracis spores. A preferred number of bilayers are about 5 to about 20 bilayers; especially preferred are about 5 to about 6 bilayers. It must be emphasized that electrostatic and hydrogen bonding attractions cause the polyelectrolytes to adhere to underlying layers and pair up with oppositely charged functional groups. These attractive forces are sufficient to hold the multilayer coatings in place until they are crosslinked at the conclusion of the deposition steps. If each layer of a multilayer coating is bonded to an underlying layer at the time of deposition, it constitutes a graft multilayer structure, which is a different structure than a multilayer structure held in place by electrostatic forces, and it has different properties. An example of a graft multilayer coating is provided by Y. Liu et al. Angew. Chem. Int. Ed. Engl., 36, 2114 (1997). The Gantrez/PAMAM system described in this article builds up thickness in a linear fashion with each coating step. Multilayer coatings produced by chemical grafting at each step are expected to have more stratification and less interpenetration than coatings built up by the electrostatic LbL process, due to reduced mobility of the grafted polymer chains. More interpenetration of the chains is desirable for the present utility for stronger biocidal activity, because there will be better access to chlorinated N—H functional groups located in underlying layers.

The immersion time for each of the coating and rinsing steps may vary depending on a number of factors. Preferably, immersion of the core material into the polyionic solution occurs over a period of about 1 to about 30 min, more preferably about 2 to about 20 min Rinsing may be accomplished in one step, but a plurality of rinsing steps may be desirable in some instances.

In accordance with the present invention, polyionic material solutions can be prepared in a variety of ways. In particular, a polyionic solution of the present invention can be formed by dissolving the polyionic material(s) in water or any other solvent capable of dissolving the materials. When a solvent is used, any solvent that can allow the components within the solution to remain stable in water is suitable, e.g., an alcohol-based solvent. Suitable alcohols can include, but are not limited to, isopropyl alcohol, methanol, ethanol, and others commonly used.

Whether dissolved in water or in a solvent, the concentration of a polyionic material in a solution of the present invention can generally vary depending on the particular materials being utilized, the desired coating thickness, and a number of other factors. However, typically a relatively dilute aqueous solution of polyionic material is used. For example, a polyionic material concentration can be between about 0.001% to about 0.25% by weight, preferably between about 0.005% to about 0.10% by weight, or more preferably between about 0.01% to about 0.05% by weight.

After deposition on the substrate is completed, the LbL coatings are crosslinked by appropriate physical or chemical treatment. Prior to this, the coatings are held in place mainly by electrostatic attraction and hydrogen bond interactions. For example, by heating to at least 100° C. for at least 1 h the amine and carboxylate containing groups of adjacent layers react to form linking amide bonds [see, for example, Harris, J. H., et al., J. Am. Chem. Soc. 121, 1978 (1999)]. Although a higher extent of crosslinking is obtained at higher temperatures, the maximum temperature that can be used in the application is dictated by the thermal stability of the substrate. For example, commercial polypropylene microplates cannot withstand heating above 120° C. In addition to this, analysis of chlorine content by titration shows that coated glass substrates crosslinked at 180° C. have a lower chlorine content than identical coated substrates crosslinked at 120° C.

If heating of the substrates with LbL coatings is not possible, chemical crosslinking may be an acceptable alternative. For example, carboxylate and amine groups may be converted to amide linkages by treatment with 1,3-dicyclohexylcarbodiimide (DCC) or 1-ethyl-3-(3-dimethyl-aminopropyl) carbodiimide (EDC) [see, for example, Richert, L., et al., Biomacromolecules, 5, 284 (2004)].

Because bleach is an economical source for forming N—Cl in these coatings, it is preferred. Chlorination of the N—H bonds in the LbL-coated substrates was done by immersion for about 20-30 min in aqueous solutions of commercial bleach (NaOCl) diluted to about 10% of the original concentration (about 0.6% by weight), and adjusted to about pH 7 by addition of a suitable amount of hydrochloric acid. Coatings treated with bleach adjusted to about pH 7 have stronger biocidal activity than coatings treated with bleach with no pH adjustment. This is believed to be due to double chlorination of primary amine groups present in the coating to —NCl₂. At more basic pH, only monochlorination of the primary amine groups to —NHCl occurs. After chlorination, the samples were washed by immersion in deionized water, followed by copious rinsing with deionized water. It is possible that immersion of a coated substrate or spraying or wiping its surface with bleach could done for from about 10 sec to about 2 h, preferably from about 20 min to about 1 h, and more preferably about 20 min. The concentration of the bleach is from about 0.12 to about 6% by weight, preferably about 0.6% by weight. To probe the active chlorine content of representative LbL-coated substrates, glass microscope slides with differing coatings variants were analyzed by iodometric titration, in a method similar to that described in US2007/0224161. Briefly, glass microscope slides were cut to approximately 1″ by 1″ (2.5 cm by 2.5 cm) in size prior to cleaning and coating. The coated slides were treated with 1 g of KI in 40 mL water for one h. The formed I₂ was titrated with 0.01 M of standardized aqueous sodium thiosulfate solution. Dividing the number of equivalents of sodium thiosulfate consumed by the approximate surface area of the slides (12.5 cm²) yields the surface concentration of chlorine, which is conveniently expressed in nmoles/cm².

However, it is possible to have N—Br used in these coatings. A typical method for preparing the present biocidal polymers with N—Br groups is described in U.S. Pat. No. 5,889,130, in which the polymers are treated with aqueous sodium hydroxide (NaOH), followed by liquid bromine (Br₂).

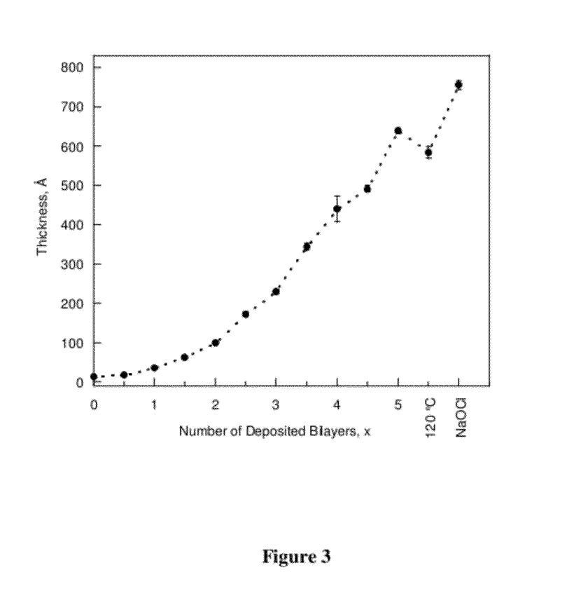

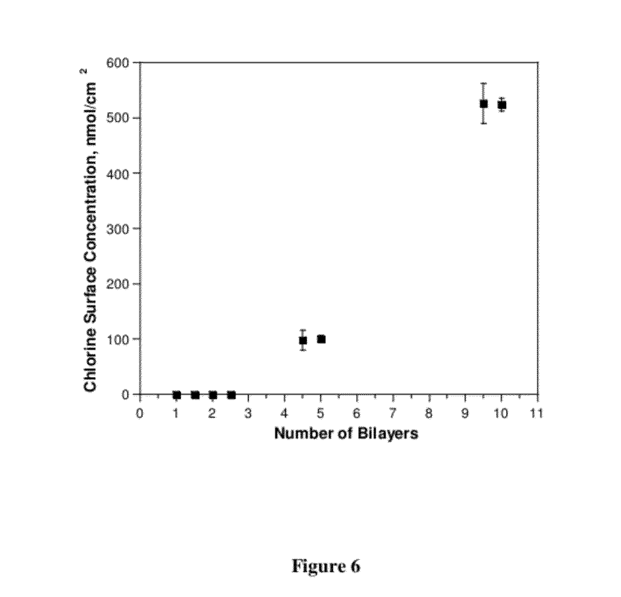

The process of building up the thickness of an LbL coating by sequential deposition of a silicon substrate in 0.01 M PAA adjusted to about pH 3.5 and 0.01 M PAH adjusted to about pH 8.5, followed by crosslinking and chlorination is illustrated by ellipsometry data in FIG. 3. This is clearly a non-linear process in which thickness builds up much more quickly after deposition of the first 2-4 layers. Because of this, the thicker coatings will contain significantly more N—H functional groups that are available for reaction with chlorine for conversion to biocidal N—Cl functional groups. Hence, these coatings contain approximately 100 nmol/cm² chlorine with five bilayers, and over 500 nmol/cm² with ten bilayers, as seen in FIG. 6. In contrast, a biocidal coating composed of surface-grafted PEI, followed by surface-grafted PAA is reported in J. M. Goddard and J. H. Hotchkiss, J. Food Prot., 71, 2042 (2008). This coating contains between 4.8 and 7.3 nmol/cm² chlorine, which is a relatively small surface density of chlorine. Whereas the rapid non-linear buildup of weak polyelectrolyte layers afforded by the electrostatic LbL method of this invention provides an exponential increase of thickness, and hence, an exponentially higher surface concentration of N—Cl functional groups.

Uses.

The present invention provides a durable coating which can be applied to both hard surfaces and fabrics, which provides sustained biocidal activity against pathogenic microorganisms including bacterial spores, and which coating activity can also be regenerated multiple times by treatment with hypochlorite, or other suitable sources of halogen.

These coatings are useful in a variety of settings for hazard reduction caused by such spores, such as 1) in hospitals, for example to coat bed handrails, call buttons, disposable gowns, instruments, bedpans, and other surfaces that require a longer spore clearance than is usually available from a disinfectant, 2) in air systems, for example by coating the filters and/or conduits to remove spores in the air stream, 3) in water systems, for example by coating pipes as outlets from water supplies, or filters, or 4) any place that can be coated for longer treatment to eliminate spores and reduce the hazard from such spores. Also the substrate that is coated can be sterilized to spores or bacteria prior to using the coating for additional longer sterilization. However, this coating is not intended for use in diagnostic applications or assays.

The invention will be further clarified by a consideration of the following examples, which are intended to be purely exemplary of the present invention.

### Example 1

### Preparation of Coating Solutions

A: Polyacrylic Acid (PAA) Solution

A solution of PAA having an average molecular weight of about 240,000 was prepared by dissolving a suitable amount of PAA in water to have [PAA]=0.01 M. Concentration was calculated based on the repeating unit in PAA. Once dissolved, the pH of the PAA solution was adjusted to a desired value.

B: Poly(Allylamine Hydrochloride) (PAH) Solution

A solution of PAH having an average molecular weight of about 70,000 was prepared by dissolving a suitable amount of the material in water to form a 0.01 M PAH solution. Concentration was calculated based on the repeating unit in PAH. Once dissolved, the pH of the PAH solution was adjusted to a desired value.

C: Poly(sodium 4-styrene-sulfonate) (PSS)

A solution of PSS having an average molecular weight of about 70,000 was prepared by dissolving a suitable amount of the material in water to form a 0.01 M PSS solution. Concentration was calculated based on the repeating unit in PSS. No effort was made to adjust the pH in this instance.

### Example 2

### Preparation of LbL Coatings on Microplates

LbL coatings with and without biocidal activity were made on assay plates (Corning 360 μL 96-Well Polypropylene Assay Plates). Coatings were formed by immersion of the substrates in aqueous polyelectrolyte solutions (as prepared in Example 1) alternating sequentially between anionic and cationic polyelectrolytes. The microplates were coated by whole immersion in 1 L beakers filled with polyelectrolyte coating solution, followed by 1 L beakers filled with deionized water rinse solution.

Alternatively, the microplates were sawed in half or thirds to facilitate immersion in smaller volumes of coating and rinse solutions.

A: Coating Having 2 Bilayers: PAA/PAH/PAA/PAH

The microplates were dipped in a PAA solution (0.01 M, pH 3.5) for 20 min, rinsed with ultra-pure water, then dipped in a PAH solution (0.01 M, pH 8.5) for 20 min, followed by rinsing. One more bilayer was added by alternatively dipping in the PAA and PAH solutions, with a rinse step between each coating step.

B: Coating Comprising 2.5 Bilayers: PAA/PAH/PAA/PAH/PAA

The microplates were dipped in a PAA solution (0.01 M, pH 3.5) for 20 min, rinsed with ultra-pure water, then dipped in a PAH solution (0.01 M, pH 8.5) for 20 min, followed by rinsing. One and one half more bilayers are added by alternatively dipping in the PAA and PAH solutions, ending with the PAA solution, with a rinse step between each coating step.

C: Coating Comprising 5 Bilayers: [PAA/PAH]₅

The microplates were dipped in a PAA solution (0.01 M, pH 3.5) for 20 min, rinsed with ultra-pure water, then dipped in a PAH solution (0.01 M, pH 8.5) for 20 min, followed by rinsing. Four more bilayers were added by alternatively dipping in the PAA and PAH solutions, with a rinse step between each coating step.

D. Coating Comprising 5.5 Bilayers: [PAA/PAH]₅PAA

The microplates were dipped in a PAA solution (0.01 M, pH 3.5) for 20 min, rinsed with ultra-pure water, then dipped in a PAH solution (0.01 M, pH 8.5) for 20 min, followed by rinsing. Four and one half more bilayers were added by alternatively dipping in the PAA and PAH solutions, ending with the PAA solution, with a rinse step between each coating step.

E: Coating Comprising 10 Bilayers: [PAA/PAH]₁₀

The microplates were dipped in a PAA solution (0.01 M, pH 3.5) for 20 min, rinsed with ultra-pure water, then dipped in a PAH solution (0.01 M, pH 8.5) for 20 min, followed by rinsing. Nine more bilayers were added by alternatively dipping in the PAA and PAH solutions, with a rinse step between each coating step.

F: Coating Comprising 10.5 Bilayers: [PAA/PAH]₁₀PAA

The microplates were dipped in a PAA solution (0.01 M, pH 3.5) for 20 min, rinsed with ultra-pure water, then dipped in a PAH solution (0.01 M, pH 8.5) for 20 min, followed by rinsing. Nine and one half more bilayers were added by alternatively dipping in the PAA and PAH solutions, ending with the PAA solution, with a rinse step between each coating step.

G: Coating Comprising 5.5 Bilayers with PSS as the Outermost Layer: [PAA/PAH]₅PSS

The microplates were dipped in a PAA solution (0.01 M, pH 3.5) for 20 min, rinsed with ultra-pure water, then dipped in a PAH solution (0.01 M, pH 8.5) for 20 min, followed by rinsing. Four more bilayers were added by alternatively dipping in the PAA and PAH solutions, ending with the PAA solution, with a rinse step between each coating step. Finally, the microplates were dipped in a PSS solution (0.01 M) for 20 min, and rinsed with ultra-pure water.

### Example 3

### Preparation of LbL Coatings on Glass Slides

For biocidal testing against E. coli bacteria, LbL coatings with and without biocidal activity were deposited on 1″ by 3″ glass microscope slides. For analysis of chlorine by titration, the slides were first cut to 1″ by 1″ prior to cleaning and coating. Coatings were formed by immersion of the substrates in aqueous polyelectrolyte solutions (as prepared in Example 1) alternating sequentially between cationic and anionic polyelectrolytes. It was found that that anionic polyelectrolytes such as PAA do not adhere substantially to glass and silicon substrates, and hence cationic polyelectrolytes, such as PAH were used as the first layer in later Examples. The glass slides were coated by whole immersion in 8 oz. jars filled with polyelectrolyte coating solution, followed by 400 mL beakers filled with deionized water rinse solution.

A: Coating Having 1.5 Bilayers: PAH/PAA/PAH

The glass slides were dipped in a PAH solution (0.01 M, pH 8.5) for 20 min, rinsed with ultra-pure water, then dipped in a PAA solution (0.01 M, pH 3.5) for 20 min, followed by rinsing. One more layer was added by dipping in the PAH solution, with a rinse step at the end.

B: Coating Having 2 Bilayers: [PAH/PAA]₂

The glass slides were dipped in a PAH solution (0.01 M, pH 8.5) for 20 min, rinsed with ultra-pure water, then dipped in a PAA solution (0.01 M, pH 3.5) for 20 min, followed by rinsing. One more bilayer was added by alternatively dipping in the PAH and PAA solutions, with a rinse step between each coating step.

C. Coating Comprising 4.5 Bilayers: [PAH/PAA]₄PAH

The microplates were dipped in a PAH solution (0.01 M, pH 8.5) for 20 min, rinsed with ultra-pure water, then dipped in a PAA solution (0.01 M, pH 3.5) for 20 min, followed by rinsing. Three and one half more bilayers were added by alternatively dipping in the PAH and PAA solutions, ending with the PAH solution, with a rinse step between each coating step.

D: Coating Comprising 5 Bilayers: [PAH/PAA]₅

The microplates were dipped in a PAH solution (0.01 M, pH 8.5) for 20 min, rinsed with ultra-pure water, then dipped in a PAH solution (0.01 M, pH 3.5) for 20 min, followed by rinsing. Four more bilayers were added by alternatively dipping in the PAH and PAA solutions, with a rinse step between each coating step.

E: Coating Comprising 9.5 Bilayers: [PAH/PAA]₉PAH

The microplates were dipped in a PAH solution (0.01 M, pH 8.5) for 20 min, rinsed with ultra-pure water, then dipped in a PAA solution (0.01 M, pH 3.5) for 20 min, followed by rinsing. Eight and one half more bilayers were added by alternatively dipping in the PAA and PAH solutions, ending with the PAA solution, with a rinse step between each coating step.

F: Coating Comprising 10 Bilayers: [PAH/PAA]₁₀

The microplates were dipped in a PAH solution (0.01 M, pH 8.5) for 20 min, rinsed with ultra-pure water, then dipped in a PAH solution (0.01 M, pH 3.5) for 20 min, followed by rinsing. Nine more bilayers were added by alternatively dipping in the PAH and PAA solutions, with a rinse step between each coating step.

### Example 4

### Thermal Crosslinking of Polypropylene Microplates or Glass Slides with LbL Coatings

Coated microplates of Example 2 or glass slides of Example 3 were placed in the middle shelf of a thermostated laboratory oven with the temperature set to 120° C., and kept in place overnight (about 16-18 h) to have crosslinking occur. In the case of glass slides, some of the substrates were heated to 180° C. overnight in the oven.

### Example 5

### Chlorination of Polypropylene Microplates or Glass Slides with PAA/PAH LbL Coatings

Coated microplates both with and without thermal crosslinking, and glass slides with thermal crosslinking were immersed in commercial bleach (NaOCl) solution (diluted to 10% of the original concentration with deionized water, pH 7.0) for 20 min, and then washed with copious amounts of deionized water. After rinsing several times, iodide starch test paper did not change color when immersed in the rinse water, indicating the absence of bleach in the rinse water.

Examples 1-4 illustrate the described LbL process of FIG. 1.

In general the chlorination procedure is as described above. However, it is possible to regenerate the coating after use. The regeneration of chlorine content for activity of the LbL surface is typically accomplished by immersion of coated articles in chlorine solution, or alternatively if it is a very large surface area, wetting with a solution by sponging on, followed by wiping down. Commercial Clorox bleach is typically described as having 6% active chlorine. Typical immersion times vary from 20 min to one h, and the concentration varies from 0.12% active chlorine to the full 6%. For these present LbL coatings, from about 10 sec to 2 h, at a concentration of about 0.01% to 6% chlorine is satisfactory for regeneration of the surface; preferably 20 min of immersion at 0.6% chlorine (10% dilution of commercial bottle). Apparently, bleach best retains its activity when stored as received (e.g., 6%), and should only be diluted just prior to use.

### Example 6

### Antimicrobial Activity of Polypropylene Microplates with LbL Coatings

Polypropylene Microplates with two or more LbL bilayer coatings with and without crosslinking, and with and without hypochlorite treatment, were tested for biocidal activity against Sterne strain B. anthracis spores.

Effects of the number of layers, the outermost layer and crosslinking on biocidal activity were studied. An aqueous solution of spores containing 10⁶ viable spores was applied to a coated well in the 96 well microplate. The total volume applied to a well was 50 μL Immediately after application, the applied volume was re-pipetted to ensure that the well bottom was covered. Plate wells containing the 50 μL spore solution were placed into a vacuum apparatus that allowed complete drying within 50 min (drying rate is about 1 μL per min). The optimum time required for the biocidal action is determined by setting up enough wells to test a range of exposure times (2, 4, 6, 12, 18 and 24 h). For this set of experiments, 24 h of incubation time was optimum (˜99% killing). Three replicates were performed per coating formulation. Dried spores were recovered from the coated surfaces by application of 0.04% BSA/0.03% sodium thiosulfate solution, which deactivated the N—Cl groups. Each tested well received 200 μL, and this volume was used to wash each well by pipetting repeatedly for 30 sec. The BSA-Thiosulfate solution formed bubbles, so the tip was immersed inside the well during the wash. The washes were collected and 100 μL was used to perform four 10-fold dilutions, down to 10⁻³. BSA-thiosulfate solution was used to prepare the series dilution and the remaining volume from the wash was reserved. One hundred μL of the dilution series and the remaining wash volumes were plated on pre-dried BHI-agar plates. The plates were spread with the spore solution using L-spreaders or loop inoculation technique. The plates were incubated at 37° C., and colonies are enumerated after 16-18 h growth.

Coated microplates not treated with hypochlorite solution served as negative controls. The number of colonies was compared for the same type of coating with and without chlorination. Results of antimicrobial activity assays are shown in Table 1 below.

TABLE 1

| | Thermal | Log Decrease in |
|---|---|---|
| PEM Coating | Crosslinking | Spore Count |
| [PAA/PAH]₂/NaOCl | Yes | 1.02 |
| [PAA/PAH]₂/PAA/NaOCl | Yes | 0.66 |
| [PAA/PAH]₅/NaOCl | Yes | 0.62 |
| [PAA/PAH]₅/PAA/NaOCl | Yes | 2.64 |
| [PAA/PAH]₅/NaOCl | No | ~0 |
| [PAA/PAH]₅/PAA/NaOCl | No | ~0 |
| [PAA/PAH]₅/PSS/NaOCl | Yes | ~0 |
| [PAA/PAH]₅/PSS/NaOCl | No | ~0 |
| [PAA/PAH]₁₀/NaOCl | Yes | 0.22 |
| [PAA/PAH]₁₀/PAA/NaOCl | Yes | 1.13 |

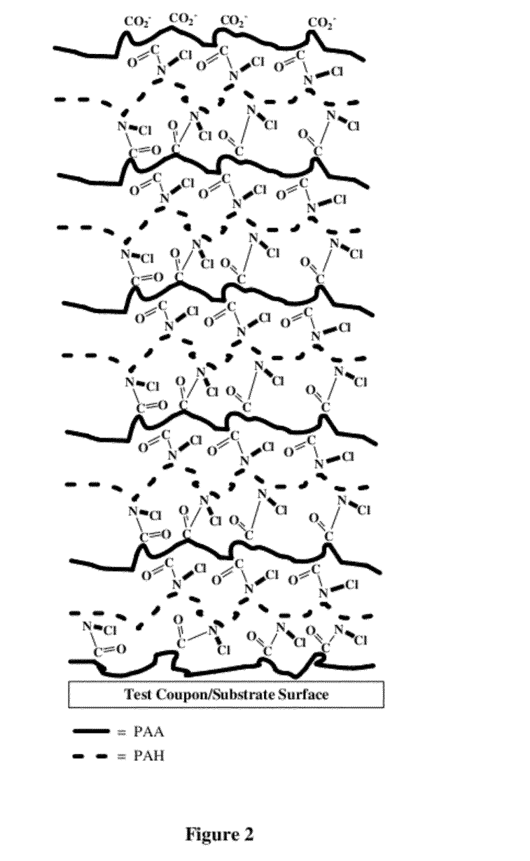

The results in Table 1 indicate that for coatings composed of 5 or more bilayers, stronger biocidal activity against Sterne strain B. anthracis spores was obtained when PAA is the outermost layer, compared with PAH as the outermost layer. The strongest biocidal activity was obtained with 5.5 bilayers. No biocidal activity was observed when PSS was substituted for PAA as the outermost anionic layer. Also, no biocidal activity was observed when the LbL coatings were not thermally crosslinked. This preferred coating, [PAA/PAH]₅/PAA/120° C./NaOCl LbL formulation, is illustrated in FIG. 2.

### Example 7

### Antimicrobial Activity of Glass Sides with LbL Coatings

1″×3″ glass microscope slides with five and ten PAH/PAA LbL bilayer coatings, crosslinked at 120° C., and treated with hypochlorite were tested for antimicrobial activity against Escherichia coli (ATCC11229). Slides without hypochlorite treatment served as controls. Films of bacterial cells were applied in quadruplicate to both active and controls slides for exposure times of 20 to 120 min. After exposure, the slides were transferred to individual vessels containing neutralizing culture media, and assayed quantitatively for survivors. Tryptic Soy Agar with 5% Sheep Blood was used as the culture media, and 0.1% Sodium Thiosulfate was used as the neutralizer. The results from the untreated control carriers were used to perform the calculations. The results of antimicrobial assays against E. coli are shown in Table 2 below.

TABLE 2

| | Exposure | Log |
|---|---|---|
| PEM Coating | Time, min | Reduction |
| [PAH/PAA]₅/NaOCl | 20 | 0.24 |
| [PAH/PAA]₅/NaOCl | 120 | 3.2 |
| [PAH/PAA]₁₀/NaOCl | 20 | 2.9 |
| [PAH/PAA]₁₀/NaOCl | 60 | 4.6 |

The results in Table 2 indicate that antimicrobial activity against E. coli is significantly faster with ten bilayers than with five bilayers.

### Example 8

### Chlorine Content

The results of the titration experiments to determine chlorine content of several coating variants of LbL-coated glass slides are shown in FIG. 6. For 1 through 2.5 bilayers, the titration method was not sufficiently sensitive to detect the relatively small amount of chlorine in the coatings. For 4.5 and 5 bilayers, the surface concentration of chlorine is about 100 nmol/cm². For 9.5 and 10 bilayers, the surface concentration of chlorine is over 500 nmol/cm². It can be seen that the amount of chlorine the coatings can store and release increase exponentially with increasing numbers of layers.

### Example 9

### Comparative—WO 2008/156636

WO 2008/156636 is a related published patent application (by the same assignee as the present invention) that describes antimicrobial polymer coatings that convert bacterial spores into their more vulnerable vegetative form to kill them. The spores are supposed to be germinated when they come in contact with the polymer coatings of the comparative publication, because small molecule nutrients known to induce spore germination are encapsulated within these coatings and slowly released. These comparative coatings also contain either quaternary ammonium groups, chlorinated hydantoin groups, or a mixture of these two as biocidal functionalities. The compositional and architectural polymer variants that are described in the teachings and claims of this comparative publication include hyperbranched polyamides, PAMAM dendrimers, and PEI. PEMs fabricated by the iterative LbL process that are composed of these biocidal polymers are also mentioned in their claims. However, attempts to systematically test the claimed compositions of WO 2008/156636 for biocidal activity against Bacillus anthracis spores demonstrated that they were not nearly as strongly biocidal as initially expected.

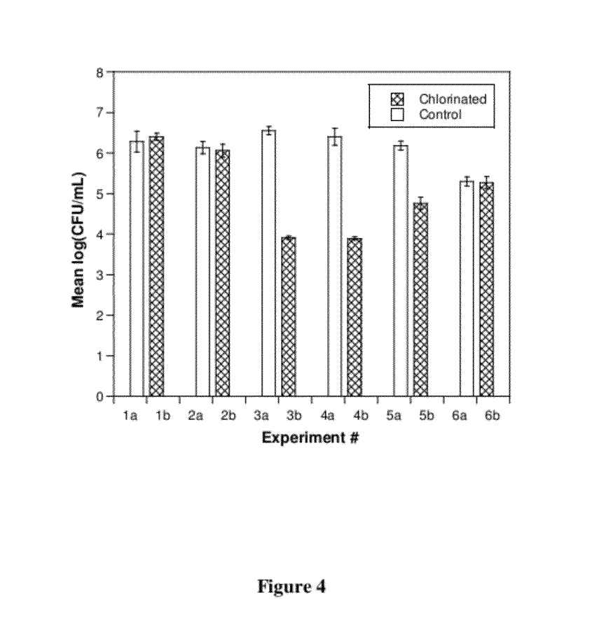

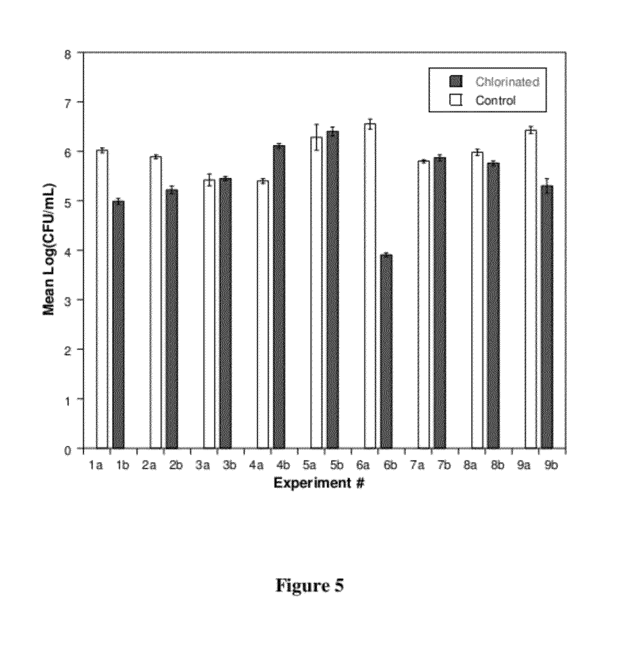

Conversely, different PEM polymer compositions were found to have unexpectedly strong biocidal activity. The key results of these experiments are summarized in Tables 3 and 4, and this data is also plotted as bar graphs in FIGS. 4 and 5, respectively. In all of these cases the biocidal activity of the comparative polymer coatings arose from amine and amide functional groups, of which the latter were formed by thermal crosslinking between adjacent PAA and PAH polyelectrolyte layers, followed by chlorination by immersing the coatings in dilute bleach (NaOCl) for 20 min. For each comparative coating variant, the non-chlorinated versions (e.g., “a” experiments) were shown to be inactive, and consequently serve as control data points, while the chlorinated versions (e.g., “b” experiments) were biocidal in several cases. Biocidal activity of the comparative coatings was measured as the log decrease of viable spores in units of CFU/mL. If the spore counts do not decrease significantly (or increase) when transitioning between the control (a) and chlorinated coatings (b), then the coating was deemed to be inactive.

Polymer coatings of the present invention in Table 3 are all fabricated from the LbL method, and have PEM structures. Each coating variant had at least 5 PAA/PAH layer pairs, and some variants had additional layers. In each case PAA was the initial (bottom) layer to come in contact with the coated substrate (300 μL polypropylene microplates). However, whichever layer was on the bottom was believed to be of minor importance, while the top layer was of greater importance. For example, Table 3 and FIG. 4 show there was no decrease in B. anthracis spore viability between experiment 1a and 1b, in which cationic PAH is the top layer of a 5-bilayer coating. However, there was a 2.64 log decrease in spore viability between experiment 3a and 3b, where anionic PAA was the top layer of a 5.5 bilayer coating.

The encapsulation of a mixture of alanine and inosine as small molecule germinants in the comparative coating had no significant effect on the biocidal activity of the coatings against spores. Consequently, there was no significant difference between experiments 1a & 1b and 2a & 2b, all of which showed no biocidal activity against spores. Also, experiments 3a & 3b and 4a & 4b had similar biocidal activity, which was due to their chlorinated amide functional groups and their anionic surfaces, while the presence or absence of encapsulated alanine and inosine germinants was irrelevant to their activity.

The trend of enhanced biocidal activity with PAA top layers was continued when PAMAM with chlorinated hydantoin end-groups was used as a cationic polyelectrolyte component in the PEM coatings of the present invention. Consequently, in experiments 6a & 6b in which hydantoin-PAMAM was the top layer, no biocidal activity was observed, while at least some biocidal activity was observed in experiments 5a & 5b in which PAA was deposited on top of hydantoin-PAMAM, though it was inferior to experiments 3a & 3b where PAH and PAA are the only components of the multilayer coating.

TABLE 3

| | | | | Decrease |
|---|---|---|---|---|
| | Experiment | log | Standard | log |
| LbL Coating | # | (CFU/mL) | Deviation | (CFU/mL) |
| [PAA/PAH]₅/120° C. | 1a | 6.28 | 0.26 | |
| [PAA/PAH]₅/120° C./ | 1b | 6.40 | 0.09 | −0.12 |
| NaOCl | | | | |
| [PAA/PAH]₅/120° C./ | 2a | 6.13 | 0.15 | |
| alanine&inosine | | | | |
| [PAA/PAH]₅/120° C./ | 2b | 6.06 | 0.16 | 0.07 |
| NaOCl/ | | | | |
| alanine&inosine | | | | |
| [PAA/PAH]₅/PAA/ | 3a | 6.55 | 0.10 | |
| 120° C. | | | | |
| [PAA/PAH]₅/PAA/ | 3b | 3.91 | 0.04 | 2.64 |
| 120° C./NaOCl | | | | |
| [PAA/PAH]₅/PAA/ | 4a | 6.40 | 0.21 | |
| 120° C./ | | | | |
| alanine&inosine | | | | |
| [PAA/PAH]₅/PAA/ | 4b | 3.89 | 0.04 | 2.51 |
| 120° C./NaOCl/ | | | | |
| alanine&inosine | | | | |
| [PAA/PAH]₅/ | 5a | 6.18 | 0.11 | |
| PAA/hydantoin- | | | | |
| PAMAM/PAA/ | | | | |
| 120° C. | | | | |
| [PAA/PAH]₅/ | 5b | 4.76 | 0.15 | 1.42 |
| PAA/hydantoin- | | | | |
| PAMAM/PAA/ | | | | |
| 120° C./NaOCl | | | | |
| [PAA/PAH]₅/[PAA/ | 6a | 5.30 | 0.11 | |
| hydantoin-PAMAM]₂/ | | | | |
| 120° C. | | | | |
| [PAA/PAH]₅/ | 6b | 5.27 | 0.15 | 0.03 |
| [PAA/hydantoin- | | | | |
| PAMAM]₂/120° C./ | | | | |
| NaOCl | | | | |

### Example 10

### Layers of Coating

The experimental results shown in Table 4 probed the impact of having smaller and larger numbers of layer pairs on the biocidal activity of the coatings of the present invention, as well as the impact of crosslinking, and using PSS as the anionic top layer in place of PAA. The data from Table 4 is also plotted as bar graphs in FIG. 5. For two layer pairs, the relative activity of PAH vs. PAA top layers was reversed, with PAH having the stronger activity in experiment 1b vs. PAA top layer in experiment 2b. For ten bilayers the original trend was restored, with PAA top layer having the stronger activity (e.g., experiment 9b vs. 8b). Of the 2, 5 and 10 bilayer variants tested, 5 bilayers had the optimal biocidal activity (e.g., experiment 6b). If thermal crosslinking was not carried out prior to treatment with bleach, no biocidal activity was observed regardless of whether PAH or PAA was the top layer (e.g., experiments 3b and 4b vs. 6b). Also, if PSS was used as an anionic top layer in place of PAA, no biocidal activity was observed (e.g., experiment 7b). While not wishing to be bound by theory, it is believed that this result was because amide N—H bonds were needed in the vicinity of the coating surface.

TABLE 4

| | | | | Decrease |
|---|---|---|---|---|
| | Experiment | log | Standard | log |
| LbL Coating | # | (CFU/mL) | Deviation | (CFU/mL) |
| [PAA/PAH]₂/120° C. | 1a | 6.02 | 0.05 | |
| [PAA/PAH]₂/120° C./ | 1b | 4.99 | 0.06 | 1.03 |
| NaOCl | | | | |
| [PAA/PAH]₂/PAA/ | 2a | 5.89 | 0.04 | |
| 120° C. | | | | |
| [PAA/PAH]₂/PAA/ | 2b | 5.22 | 0.08 | 0.67 |
| 120° C./NaOCl | | | | |
| [PAA/PAH]₅ | 3a | 5.42 | 0.12 | |
| [PAA/PAH]₅/NaOCl | 3b | 5.45 | 0.04 | −0.03 |
| [PAA/PAH]₅/PAA | 4a | 5.40 | 0.05 | |
| [PAA/PAH]₅/ | 4b | 6.11 | 0.05 | −0.71 |
| PAA/NaOCl | | | | |
| [PAA/PAH]₅/120° C. | 5a | 6.28 | 0.26 | |
| [PAA/PAH]₅/ | 5b | 6.40 | 0.09 | −0.12 |
| 120° C./NaOCl | | | | |
| [PAA/PAH]₅/PAA/ | 6a | 6.55 | 0.10 | |
| 120° C. | | | | |
| [PAA/PAH]₅/PAA/ | 6b | 3.91 | 0.04 | 2.64 |
| 120° C./NaOCl | | | | |
| [PAA/PAH]₅/PSS/ | 7a | 5.80 | 0.03 | |
| 120° C. | | | | |
| [PAA/PAH]₅/PSS/ | 7b | 5.87 | 0.06 | −0.07 |
| 120° C./NaOCl | | | | |
| [PAA/PAH]₁₀/120° C. | 8a | 5.98 | 0.06 | |
| [PAA/PAH]₁₀/ | 8b | 5.76 | 0.05 | 0.22 |
| 120° C./NaOCl | | | | |
| [PAA/PAH]₁₀/ | 9a | 6.43 | 0.07 | |
| PAA/120° C. | | | | |
| [PAA/PAH]₁₀/PAA/ | 9b | 5.30 | 0.15 | 1.13 |
| 120° C./NaOCl | | | | |

Although the invention has been described with reference to its preferred embodiments, those of ordinary skill in the art may, upon reading and understanding this disclosure, appreciate changes and modifications which may be made which do not depart from the scope and spirit of the invention as described above or claimed hereafter.

What is claimed is:

1. A composition comprising an antimicrobial bilayer coating on a substrate, which coating comprises:
(1) a polyionic material, in alternating layers, where one layer is a cationic polymer containing —NHR₁ or —C(O)NHR₂ groups, where R₁ and R₂ are independently hydrogen, straight- or branch-chain C₁-C₁₀ alkyl, phenyl, benzyl, or C₆-C₁₄ aryl; and another layer is an anionic polymer containing —COOH or COOR groups, where R is straight- or branch-chain C₁-C₁₀ alkyl, phenyl, benzyl, or C₆-C₁₄ aryl; and
(2) At least two full bilayers are coated on the substrate; and
(3) the layers are crosslinked through amide, imide, urea or carbamate bonds; and
(4) at least 1% of the amine or amide N—H groups in the coating are converted to N—X, where X is Cl or Br.

2. The composition of claim 1 wherein the polyionic materials have a molecular weight Mₙ of about 2,000 to about 500,000.

3. The composition of claim 1 wherein about 5 to about 20 bilayers are present.

4. The composition of claim 3 wherein about 5 to about 6 bilayers are present.

5. The composition of claim 1 wherein the outermost layer is an anionic polymer.

6. The composition of claim 1 where the anionic polymer is polymethacrylic acid (PMA), polyacrylic acid (PAA), poly(4-styrenesulfonic acid) (PSS), a maleic or fumaric acid copolymer, polyamidoamine dendrimers (PAMAM) with carboxylate end-groups, or hyperbranched polyamides, polyamidoamines, polyurethanes or polyureas, each with carboxylate end-groups.

7. The composition of claim 6 wherein the anionic polymer is polyacrylic acid (PAA).

8. The composition of claim 1 where the cationic polymer is poly(allylamine hydrochloride) (PAH), poly(ethyleneimine) (PEI), polydiallyl dimethyl ammonium chloride (PDDA), polyamidoamine dendrimers (PAMAM) or polypropylenimine dendrimers (PPI), or hyperbranched polyamides, polyamidoamines, polyurethanes or polyureas.

9. The composition of claim 8 where the cationic polymer is poly(allylamine hydrochloride) (PAH).

10. The composition of claim 1 where the cationic behaving polymer is polyacrylamide (PAAm).

11. The composition of claim 1 wherein the N—X groups are N—Cl and at least 10% of the amine or amide N—H groups in the coating are converted to N—Cl.

12. A process for preparing the composition of claim 1 which comprises:
(1) applying to a substrate the polyionic bilayer of claims 1; and
(2) forming amide bonds between the cationic and anionic polymer layers by a chemical dehydrating agent; or
(3) crosslinking the amide bonds in the bilayers by thermal means; and
(4) contacting the coating for about 10 sec to about 2 h with aqueous hypochlorite or aqueous sodium hydroxide (NaOH), followed by liquid bromine (Br₂) or other suitable halogenation agent.

13. The process of claim 12 (2) wherein the chemical dehydrating agent is 1,3-dicyclohexylcarbodiimide (DCC) or 1-ethyl-3-(3-dimethyl-aminopropyl)carbodiimide (EDC).

14. The process of claim 12 (3) wherein the bilayers are heated to at least 100° C. for at least 1 h.

15. The process of claim 12 (4) wherein the aqueous hypochlorite is a solution of about 0.12 to about 6% by weight of bleach adjusted to about pH 7 or below.

16. The process of claim 15 wherein the bleach is from about 0.6 to about 10%, at about pH 7, and in contact with the coating from about 20 min to about 1 h.

17. A method for coating a substrate which comprises applying a solution containing the coating composition of any one of claims 6 or 8 in a polar organic solvent or water to a substrate and allowing the mixture to dry forming the coated substrate.

18. The method of claim 17 wherein the solution is applied by dipping or immersion of the substrate one or more times into the solution, spraying or spin coating the solution onto the substrate, or brushing or wiping the solution onto the substrate.

19. The method of claim 17 wherein the coating of claim 1 is regenerated by treating the substrate with bleach by dipping the substrate one or more times into a bleach solution, spraying the bleach solution onto the substrate, or wiping the bleach solution onto the substrate.
